(19) United States
(12) Patent Application Publication
(10) Pub. No.: US 2007/0048422 A1
(43) Pub. Date: Mar. 1, 2007

(54) Method and system for powderizing a liquid form treated material into powder form

(76) Inventor: Chen-I Cheng, Long Beach, CA (US)

Correspondence Address: Raymond Y. Chan, #128, 108 N. Ynez Ave., Monterey Park, CA, 91754, US

(21) Appl. No.: 11/217,021

(22) Filed: Aug. 30, 2005

(51) Int. Cl. A23B 4/03

(52) U.S. Cl. 426/465

(57) ABSTRACT

The present invention provides a method and system for powderizing a liquid form treated material into powder form including a treatment housing with a powderization chamber, a collection base, an injection nozzle on the top of the treatment housing, a drying unit in a lower portion of the treatment housing, and an moisture air passage provided in an upper portion of the treatment housing and a filter unit. The drying unit having a drying air passage to facilitate a tangentially injection of the air flowing therethrough into the powderization chamber. When the liquid form treated materials is injected into the powderization chamber, and a dry airflow is provided, an airflow is created. As a result, the reaction rate is greatly increased, the chance and time of decomposition of enzyme or protein during powderization is much lowered such that the resulting powder maintain a content of high enzyme activity and high nutrition value.

### BACKGROUND OF THE PRESENT INVENTION

1. Field of Invention

The present invention relates to a method and system for powderizing a liquid form treated material into powder form, and more particularly to a method and treatment for powderization with an injection nozzle and a powderization chamber for providing an optimum environment for powderization while maintaining a level of activity of enzyme of the ingredient.

2. Description of Related Arts

Nutritious plants having high level of enzyme activity are widely used for powderization. Conventional powderization device either provides a chamber for vacuum drying under very low temperature such that when a starting material such as a piece of fresh vegetable or fruit is placed in the device, the starting material will be vacuum dried and frozen to form a frozen intermediate material which is then grounded into powder. However, the nutritional value of the starting material will be destroyed under such a low temperature which is essential for the freezing and drying the material and the enzyme activity of the material will then be very low after powderization.

On the other hand, alternate method of preparing the powder from the starting material employs complicated procedure and extraordinary long period of time in order to maintain the nutritious value and high enzyme activity of the starting materials. The juice of the starting material is first extracted and mixed with a vehicle such as starch to form a mixture intermediate which is then undergone a drying process to form a solid intermediate. Then the solid intermediate is grounded to powder form. The drying process takes at least 6 to 10 hours which is a long period of time. The enzyme will be decomposed or died during this long period of time and the nutritious value and enzyme activity of the starting materials will be lowered significantly.

### SUMMARY OF THE PRESENT INVENTION

A main object of the present invention is to provide a a method and system for powderizing a liquid form treated material into powder form which is designed for providing a powderization process for powderizing a liquid form treated material.

Another object of the present invention is to provide a method and system for powderizing a liquid form treated material into powder form which is designed for providing a powderization process for powderizing a liquid form treated material with a level of enzyme activity so as to transform the material into powder form while maintaining the nutritional value and the level of enzyme activity of the treated material.

Another object of the present invention is to provide which is designed for providing a powderization process for powderizing a liquid form treated material which provides an optimum powderization condition for the powderization process such that a high level of enzyme activity of the treated materials is maintained and the powderization process is kept at a relative short period of time.

Another object of the present invention is to provide a method and system for powderizing a liquid form treated material into powder form such that a relatively high level of enzyme activity of the treated materials for the process is maintained.

In order to accomplish the above objects, the present invention provides a system for powderizing a liquid form treated material into powder form comprising:

a treatment housing having a powderization chamber and comprising a collection base in the bottom of the treatment housing;

an injection nozzle provided on the top of the treatment housing for spraying a liquid form treated materials;

a dry air passage provided in a lower portion of the treatment housing for providing a stream of air flowing into the powderization chamber of the treatment housing; and

a moisture air passage provided in an upper portion of the treatment housing comprising a filter unit allowing the passage of water and air passing out of the powderization chamber while maintaining particles inside the powderization chamber;

whereby when the liquid form treated materials is pre-treated to a predetermined relatively lower temperature and is sprayed into the powderization chamber, and a stream of dry air at a relatively higher temperature is injected into the powderization chamber through the dry air passage, the treated materials from the top of the powderization chamber will move downward and the dry air from the bottom of the powderization chamber will move upward to form a circulation, that the treated materials will be dried by the dry air stream inside the powderization chamber to form powder and deposit in the collection base in the bottom of the treatment housing. The resulting air with higher level of humidity will be exhausted through the outlet in the upper portion of the treatment housing.

The dry air passage may further be modified and designed to facilitate a tangentially injection of the air flowing therethrough into the powderization chamber.

Since the liquid form treated material is split into smaller liquid particles by the injection nozzle, the reaction surface is largely increased. Water particles are then more easily extracted from the liquid particles by the dry air and the time for forming powder is shorten substantively. As a result of the shorten time for precipitation, the chance and time of decomposition of enzyme or protein during powderization is much lowered such that the resulting powder maintain a content of high enzyme activity and high nutrition value.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of the system for powderizing a liquid form treated material into powder form according to the preferred embodiment of the present invention.

FIG. 2 illustrates a method of forming a liquid formed treated material in a powder form employing the system according to the preferred embodiment of the present invention.

### DETAILED DESCRIPTION OF THE PREFERRED EMBODIMENT

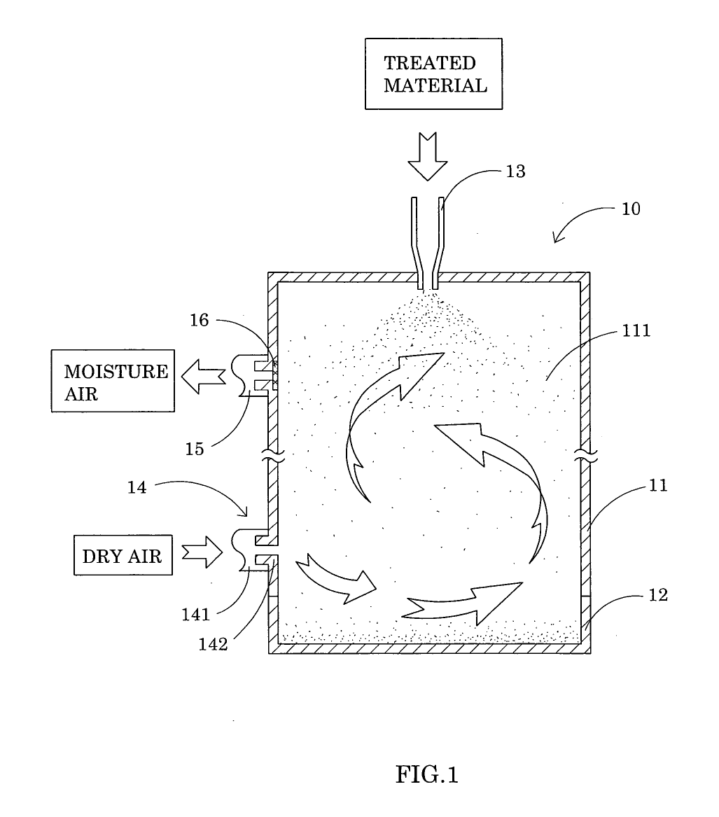

Referring to FIG. 1 of the drawings, the present invention provides a system 10 for powderizing a liquid form treated material into powder form for forming a liquid form treated material in a powder form which comprises a treatment housing 11 having a powderization chamber 111 and a collection base 12 positioned at a bottom of the powderization chamber 111. The collection base 12 may detachably connected to the treatment housing 11 such that the collection base 12 is air tightly connected to the treatment housing 11 and is capable of enclosing the bottom of the treatment housing.

The system 10 comprises an injection nozzle 13 provided on top of the treatment housing 11 for injecting the treated material into the powderization chamber 111 in a spray form at a predetermined initial temperature, a drying unit 14 provided at the treatment housing 11 for generating a drying environment, having a drying temperature higher than the initial temperature of the treated material, at a bottom portion of the treatment housing to dry the treated material so as to separate the treated material in a powdered form with a moisture thereof, and a moisture air passage 15 extended from an upper portion of the treatment housing for a moisture air exiting therefrom after the treated material is dried within the drying environment so as to collect the treated material in a powdered form at the collection base by gravity.

The drying unit 14 comprises a dry air passage 141 extended to the bottom portion of the treatment housing 11 for guiding a dry air at the drying temperature flowing into the powderization chamber 111 to dry the treated material so as to separate the treated material in a powdered form with a moisture thereof.

The dry air passage 141 has a nozzle head 141 tangentially extended into the bottom portion of the treatment housing 11 for injecting the dry air into the powderization chamber 111 to form an air circulation therewithin so as to ensure the treated material to be dried in the powderization chamber 111.

The initial temperature of the treated material is 4° C. while the drying temperature of the dry air has a range from 20° C. to 45° C. for drying the treated material within the powderization chamber 11 in about 10 minutes (less than 15 minutes) so as to maintain a high level of enzyme activity of the treated material.

The injection nozzle 13 may also further be rotatably mounted on the treatment housing 11 for spraying the treated material into the powderization chamber 111 in a spinning manner so as to evenly distribute the treated material into the powderization chamber 111.

The system 10 further comprises a filtering unit 16 provided at the moisture air passage 15 for only allowing the moisture air exiting from the powderization chamber 111 so as to keep the powdered form treated material therein. That is to say, the filtering unit 16 allows the passage of water and air passing out of the powderization chamber 111 while maintaining larger particles such as the powdered formed treated material inside the powderization chamber 111.

When initial liquid form treated materials is pre-treated to the initial temperature which is a relatively lower temperature and is sprayed into the powderization chamber 111 through the injection nozzle 13, and a stream of dry air at the drying temperature which is a relatively higher temperature than the initial temperature is injected into the powderization chamber 111 through the dry air passage, the liquid form treated materials from the top of the chamber will move downward and the dry air from the bottom of the powderization chamber 111 will move upward to form a circulation, that the liquid form treated materials will be dried by the dry air stream inside the powderization chamber 111 and form powder and deposit in the collection base 12 in the bottom of the treatment housing 11. The moisture air with higher level of humidity will be exhausted through the moisture air passage 15 in the upper portion of the treatment housing 11. The preferred temperature of the liquid form treated material is 4° C. and the preferred temperature of the dry air is between 20 and 40° C. Means for maintaining a temperature at the bottom of the powderization chamber may be provided such that a temperature difference between the top and the bottom of the system is maintained in a continuous manner for creating the particles movement inside the powderization chamber 111.

Since the liquid form treated material is split into smaller liquid particles by the injection nozzle 13, the reaction surface of the treated material is largely increased. Water particles are then more easily extracted from the liquid particles by the dry air and the time for forming powder is shorten substantively. As a result of the shorten time for powderization, the chance and time of decomposition of enzyme or protein during powderization is much lowered such that the resulting powder formed maintain a content of high enzyme activity and high nutrition value.

The liquid form treated materials used in the present invention are obtained from raw treated materials containing high content of enzyme. Cauliflower (Brassica botrytis (L) Mill), pineapple (Ananas Comosus (L) Merr), papaya (Carica papaya L.), alfalfa (Medicago sativa L) and Broccoli (Brassica oleracea L. var. italica) are the preferred raw treated materials used.

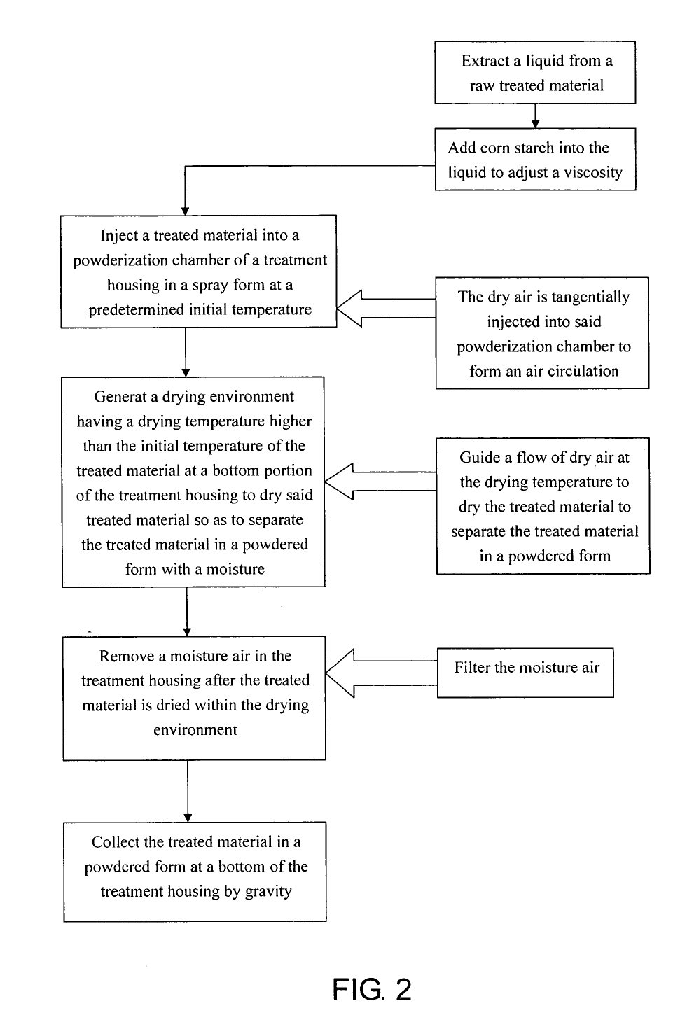

Referring to FIG. 2 of the drawings, the present invention also illustrates a method of forming a liquid formed treated material in a powder form. The method comprises the steps of:

(a) extracting or crushing liquid from a raw treated material; and

(b) adding and mixing a vehicle such as corn starch into the liquid to adjust a viscosity thereof to form the liquid form treated material.

(c) injecting the treated material into a powderization chamber of a treatment housing in a spray form at a predetermined initial temperature;

(d) generating a drying environment, having a drying temperature higher than the initial temperature of the treated material, at a bottom portion of the treatment housing to dry the treated material so as to separate the treated material in a powdered form with a moisture thereof;

(e) removing a moisture air in the treatment housing after the treated material is dried within the drying environment and forming a powdered form after a predetermined processing time; and

(f) collecting the treated material in a powdered form at a bottom of the treatment housing by gravity.

In step (b), further comprising the steps of guiding a flow of dry air at the drying temperature into the powderization chamber to dry the treated material so as to separate the treated material in a powdered form with a moisture thereof.

The dry air is tangentially injected into the powderization chamber to form an air circulation therewithin so as to ensure the treated material to be dried in the powderization chamber.

In step (c), a step of filtering the moisture air for only allowing the moisture air exiting from the powderization chamber so as to keep the powdered form treated material therein is added.

The initial temperature of the treated material is 4° C. while the drying temperature of the dry air has a range from 20° C. to 45° C., wherein a drying processing time of the treated material within the powderization chamber is about 10 minutes and is less than 15 minutes for maintaining a level of enzyme activity of the treated material.

The treated material is sprayed into the powderization chamber in a spinning manner for evenly distributing the treated material into the powderization chamber.

The environmental conditions for step (a) to (c) are maintained between 4° C. and 45° C.

The flow of the liquid form treated material entered into the powderization chamber is induced by the injection nozzle and gravity, and the temperature difference between the liquid form treated material and the dry air at the bottom of the powderization chamber. The temperature in the bottom of the powderization chamber is higher so as to ensure an upward flow of dry air. The preferred temperature in the bottom of the system is between 20° C. and 45° C. This is achieved by providing the dry air between 20° C. and 45° C. or by providing a temperature controlling means around the bottom of the powderization chamber 111.

Throughout the process, the temperature is kept between 4° C. and 45° C. The air and moisture inside the powderization chamber 111 is exhausted through the moisture air passage while the escape of powder is prevented and blocked by the filter unit 16 of the moisture air passage 15.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A system for forming a liquid form treated material in a powder form, comprising:
a treatment housing having a powderization chamber and a collection base positioned at a bottom of said powderization chamber; and
a powderization device, which comprises:
an injection nozzle provided on top of said treatment housing for injecting said treated material into said powderization chamber in a spray form at a predetermined initial temperature;
a drying unit provided at said treatment housing for generating a drying environment, having a drying temperature higher than said initial temperature of said treated material, at a bottom portion of said treatment housing to dry said treated material so as to separate said treated material in a powdered form with a moisture thereof; and
a moisture air passage extended from an upper portion of said treatment housing for a moisture air exiting therefrom after said treated material is dried within said drying environment so as to collect said treated material in a powdered form at said collection base by gravity.

2. The system, as recited in claim 1, wherein said drying unit comprises a dry air passage extended to said bottom portion of said treatment housing for guiding a dry air at said drying temperature flowing into said powderization chamber to dry said treated material so as to separate said treated material in a powdered form with a moisture thereof.

3. The system, as recited in claim 2, wherein said dry air passage has a nozzle head tangentially extended into said bottom portion of said treatment housing for injecting said dry air into said powderization chamber to form an air circulation therewithin so as to ensure said treated material to be dried in said powderization chamber.

4. The system, as recited in claim 1, further comprising a filtering unit provided at said moisture air passage for only allowing said moisture air exiting from said powderization chamber so as to keep said powdered form treated material therein.

5. The system, as recited in claim 3, further comprising a filtering unit provided at said moisture air passage for only allowing said moisture air exiting from said powderization chamber so as to keep said powdered form treated material therein.

6. The system, as recited in claim 1, wherein said initial temperature of said treated material is 4° C. while said drying temperature of said dry air has a range from 20° C. to 45° C. for drying said treated material within said powderization chamber less than 15 minutes so as to maintain a level of enzyme activity of said treated material.

7. The system, as recited in claim 5, wherein said initial temperature of said treated material is 4° C. while said drying temperature of said dry air has a range from 20° C. to 45° C. for drying said treated material within said powderization chamber less than 15 minutes so as to maintain a level of enzyme activity of said treated material.

8. The system, as recited in claim 1, wherein said injection nozzle is rotatably mounted on said treatment housing for spraying said treated material into said powderization chamber in a spinning manner so as to evenly distribute said treated material into said powderization chamber.

9. The system, as recited in claim 7, wherein said injection nozzle is rotatably mounted on said treatment housing for spraying said treated material into said powderization chamber in a spinning manner so as to evenly distribute said treated material into said powderization chamber.

10. A method of forming a liquid formed treated material into powder form, comprising the steps of:
(a) injecting said treated material into a powderization chamber of a treatment housing in a spray form at a predetermined initial temperature;
(b) generating a drying environment, having a drying temperature higher than said initial temperature of said treated material, at a bottom portion of said treatment housing to dry said treated material so as to separate said treated material in a powdered form with a moisture thereof;
(c) removing a moisture air in said treatment housing after said treated material is dried within said drying environment; and
(d) collecting said treated material in a powdered form at a bottom of said treatment housing by gravity.

11. The method as recited in claim 10, in step (b), further comprising the steps of guiding a flow of dry air at said drying temperature into said powderization chamber to dry said treated material so as to separate said treated material in a powdered form with a moisture thereof.

12. The method, as recited in claim 11, wherein said dry air is tangentially injected into said powderization chamber to form an air circulation therewithin so as to ensure said treated material to be dried in said powderization chamber.

13. The method as recited in claim 10, in step (c), further comprising a step of filtering said moisture air for only allowing said moisture air exiting from said powderization chamber so as to keep said powdered form treated material therein.

14. The method as recited in claim 12, in step (c), further comprising a step of a step of filtering said moisture air for only allowing said moisture air exiting from said powderization chamber so as to keep said powdered form treated material therein.

15. The method, as recited in claim 10, wherein said initial temperature of said treated material is 4° C. while said drying temperature of said dry air has a range from 20° C. to 45° C., wherein a drying processing time of said treated material within said powderization chamber is less than 15 minutes for maintaining a level of enzyme activity of said treated material.

16. The method, as recited in claim 14, wherein said initial temperature of said treated material is 4° C. while said drying temperature of said dry air has a range from 20° C. to 45° C., wherein a drying processing time of said treated material within said powderization chamber is less than 15 minutes for maintaining a level of enzyme activity of said treated material.

17. The method, as recited in claim 10, wherein said treated material is sprayed into said powderization chamber in a spinning manner for evenly distributing said treated material into said powderization chamber.

18. The method, as recited in claim 16, wherein said treated material is sprayed into said powderization chamber in a spinning manner for evenly distributing said treated material into said powderization chamber.

19. The method as recited in claim 10, before step (a), further comprising the steps of:
extracting liquid from a raw treated material; and
adding corn starch into said liquid to adjust a viscosity thereof to form said aqueous formed treated material.

20. The method as recited in claim 18, before step (a), further comprising the steps of:
extracting liquid from a raw treated material; and
adding corn starch into said liquid to adjust a viscosity thereof to form said aqueous formed treated material.
